(19) United States
(12) Patent Application Publication
(10) Pub. No.: US 2021/0035578 A1
(43) Pub. Date: Feb. 4, 2021

(54) CONTROL INFORMATION OBTAINING SYSTEM AND CONTROL INFORMATION OBTAINING METHOD

(71) Applicant: Panasonic Intellectual Property Management Co., Ltd., Osaka (JP)

(72) Inventors: Kiyonori KIDO, Osaka (JP); Keiichi TANAKA, Osaka (JP)

(21) Appl. No.: 16/968,234

(22) PCT Filed: Jan. 24, 2019
(86) PCT No.: PCT/JP2019/002360

§ 371 Date: Aug. 7, 2020

(30) Foreign Application Priority Data
Feb. 14, 2018 (JP) 2018-024283

(51) Int. Cl. G10L 15/22; H04L 12/28

(52) U.S. Cl. CPC G10L 15/22; H04L 12/282

(57) ABSTRACT

A control system includes: a first communication unit configured to obtain speech control information from a speech control system that outputs the speech control information for controlling a device based on a speech obtained by a speech input terminal; and a second communication unit configured to obtain related information relevant to the speech input terminal from the speech control system.

### TECHNICAL FIELD

The present invention relates to a control information obtaining system and a control information obtaining method, which are for controlling a device based on a speech.

### BACKGROUND ART

Services called virtual personal assistants (VPAs) are starting to become popular. As one form of such VPAs, there is a service which operates devices based on voices. Patent Literature (PTL) 1 discloses the home appliance control system in which a sound collecting device connectable to a network collects voice information, and controls a home appliance via the network, based on the voice information collected.

### CITATION LIST

### Patent Literature

PTL 1: WO 2014/171144

### SUMMARY OF THE INVENTION

### Technical Problem

The present invention provides a control information obtaining system and a control information obtaining method which are capable of adaptively controlling a device according to a situation in which a speech is inputted.

### Solutions to Problem

A control information obtaining system according to an aspect of the present invention includes: a first obtaining unit configured to obtain speech control information from a speech control system that outputs the speech control information for controlling a device based on a speech obtained by a speech obtaining unit; and a second obtaining unit configured to obtain related information relevant to the speech obtaining unit from the speech control system.

A control information obtaining method according to an aspect of the present invention includes: obtaining speech control information from a speech control system that outputs the speech control information for controlling a device based on a speech obtained by a speech obtaining unit; and obtaining related information relevant to the speech obtaining unit from the speech control system.

A program according to an aspect of the present invention is a program for causing a computer to execute the control information obtaining method.

### Advantageous Effect of Invention

According to the present invention, it is possible to realize a control information obtaining system and a control information obtaining method which are capable of adaptively controlling a device according to a situation in which a speech is inputted.

### BRIEF DESCRIPTION OF DRAWINGS

FIG. 1 is a block diagram illustrating a functional configuration of a speech recognition system according to Embodiment 1.

FIG. 2 is a flowchart illustrating Operation Example 1 of a control system according to Embodiment 1.

FIG. 3 is a flowchart illustrating Operation Example 2 of the control system according to Embodiment 1.

FIG. 4 is a flowchart illustrating Operation Example 3 of the control system according to Embodiment 1.

FIG. 5 is a block diagram illustrating a functional configuration of a speech recognition system according to Embodiment 2.

FIG. 6 is a block diagram illustrating a functional configuration of a speech recognition system according to Embodiment 3.

### DESCRIPTION OF EXEMPLARY EMBODIMENTS

Hereinafter, embodiments will be described in detail with reference to the drawings. Note that the embodiments below each describe a general or specific example. The numerical values, shapes, materials, elements, the arrangement and connection of the elements, steps, and the processing order of the steps, etc. presented in the embodiments below are mere examples and do not limit the present invention. Furthermore, among the structural elements in the following embodiments, structural elements not recited in any of the independent claims defining the most generic part of the inventive concept are described as optional structural elements.

Note that the drawings are schematic diagrams and do not necessarily provide strictly accurate illustrations. Throughout the drawings, the same sign is given to substantially the same configuration, and redundant description is omitted or simplified.

### Embodiment 1

### [Configuration]

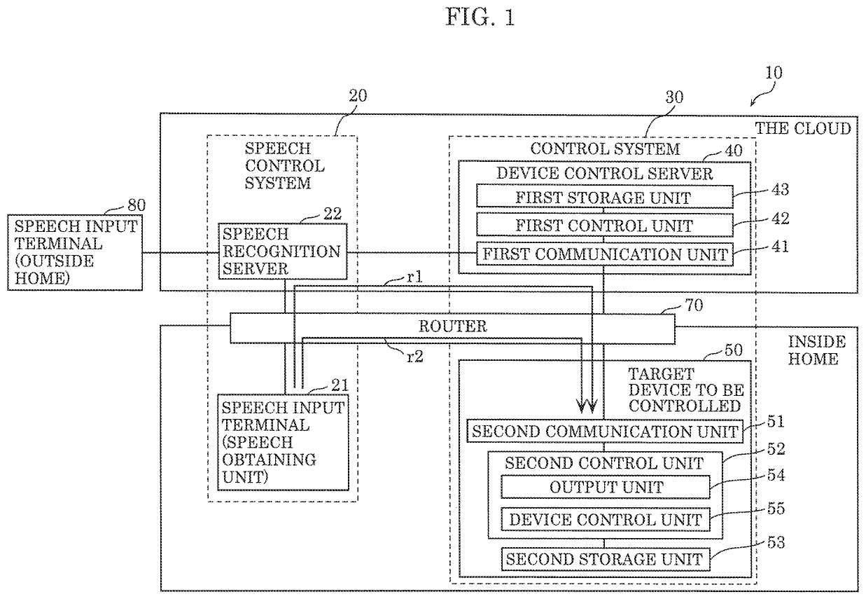

First, a configuration of a speech recognition system according to Embodiment 1 will be described. FIG. 1 is a block diagram illustrating a functional configuration of a speech recognition system according to Embodiment 1.

As illustrated in FIG. 1, speech recognition system 10 according to Embodiment 1 includes speech control system 20, control system 30, and router 70. Speech input terminal 21 of speech control system 20, target device to be controlled 50 of control system 30, and router 70 are provided inside a home. Speech recognition server 22 of speech control system 20 and device control server 40 of control system 30 each are realized as the cloud (cloud server). FIG. 1 also illustrates speech input terminal 80 provided outside the home.

### [Configuration of Speech Control System]

Speech control system 20 is a system for controlling a target device to be controlled using a speech as an input. Speech control system 20 includes speech input terminal 21 and speech recognition server 22. Besides speech input terminal 21, speech control system 20 may include another speech input terminal (e.g. speech input terminal 80).

Speech input terminal 21 is a speech input interface apparatus that obtains a speech uttered by, for example, a user inside the home. Speech input terminal 21 is one example of a speech obtaining unit. Speech input terminal 21 is, for example, a stationary terminal such as a smart speaker, and is provided in a space in which a person is estimated to be present. Speech input terminal 21 may be a mobile terminal such as a smartphone. Speech input terminal 21 may be any apparatus provided that speech input terminal 21 includes a speech collection apparatus such as a microphone and a communication circuit or the like that transmits a speech signal of a speech obtained to speech recognition server 22.

Router 70 is a relay apparatus that relays a local communication network used inside the home and a wide area network (e.g. a public network such as the Internet) used outside the home. For example, router 70 transmits a speech signal of a speech obtained by speech input terminal 21 to speech recognition server 22 in the cloud.

Speech recognition server 22 is a server that performs speech recognition processing on the speech signal transmitted from speech input terminal 21. A provider of a speech recognition service offers the speech recognition service using speech recognition server 22. Speech recognition server 22 converts the speech signal transmitted from speech input terminal 21 into, for example, text information, and then converts the text information into a command, that corresponds to the text information. The command is one example of speech control information for controlling a device based on a speech obtained by speech input terminal 21. For example, when the text information indicates a text saying “turn on the air conditioner”, such text information is converted into a command for causing the air conditioner to start operation. In addition, speech recognition server 22 transmits the command to device control server 40 of control system 30.

### [Configuration of Control System]

Control systems 30 is a system that controls, in cooperation with speech control system 20, a target device to be controlled provided inside the home. Control system 30 is one example of a control information obtaining system. Control system 30 includes device control server 40 and target device to be controlled 50.

Device control server 40 is a server that controls target device to be controlled 50 inside the home, based on the command transmitted from speech recognition server 22. A provider of a device control service offers the device control service using device control server 40. Device control server 40 includes first communication unit 41, first control unit 42, and first storage unit 43.

First communication unit 41 communicates with speech control system 20. First communication unit 41 is one example of a first obtaining unit. Specifically, first communication unit 41 obtains speech control information by communicating with speech control system 20. As described above, the speech control information is a command transmitted from speech recognition server 22, for example. First communication unit 41 is realized by, for example, a communication circuit.

First control unit 42 converts the command obtained by first communication unit 41 into an individualized command for controlling target device to be controlled 50 inside the home. In addition, first control unit 42 transmits the individualized command to target device to be controlled 50 via first communication unit 41. Note that speech recognition server 22 may, transmit text information as speech control information, and first control unit 42 may convert the text information into a command, and then convert the command into an individualized command. First control unit 42 is realized by, for example, a microcomputer or a processor.

First storage unit 43 is a storage apparatus that stores a program executed by first control unit 42. First storage unit 43 is realized by, for example, a semiconductor memory etc.

Target device to be controlled 50 is a device that receives the individualized command transmitted from first communication unit 41 of device control server 40, and operates according to the individualized command received. Target device to be controlled 50 is consumer electronics such as an air conditioner, but may be any device other than consumer electronics such as a locking apparatus of a fitting (e.g. a front door). In addition, besides target device to be controlled 50, control system 30 may include speech input terminal 21 as a target device to be controlled.

Such speech recognition system 10 allows target device to be controlled 50 to be controlled not only by speech input terminal 21 provided inside the home, but also by speech input terminal 80 present outside the home. This makes it difficult to determine from where and by whom a speech, from which speech control information originates, is inputted.

Accordingly, control system 30 in speech recognition system 10 obtains, in addition to the speech control information, related information relevant to a speech input terminal from speech control system 20. Such related information is, for example, identification information of the speech input terminal. The identification information is, for example, a media access control (MAC) address of the speech input terminal, but may be any type of information so long as the speech input terminal can be identified.

With such related information, improvement in security, control of target device to be controlled 50 according to a scene, and improvement in the usability of control system 30, etc. can be realized. That is, it is possible to realize control that is adaptively performed according to a situation in which a speech is inputted.

### [Detailed Configuration of Target Device to be Controlled]

In Embodiment 1, target device to be controlled 50 performs information processing using related information. Hereinafter, a configuration of target device to be controlled 50 will be described in detail with continuous reference to FIG. 1. Target device to be controlled 50 includes second communication unit 51, second control unit 52, and second storage unit 53.

Second communication unit 51 receives, via router 70, an individualized command transmitted from first communication unit 41 of device control server 40. In addition, second communication unit 51 is one example of a second obtaining unit. Second communication unit 51 obtains identification information of a speech input terminal which is outputted from the speech input terminal, such as speech input terminal 21 or speech input terminal 80. Second communication unit 51 is realized by, for example, a communication circuit.

Second communication unit 51 obtains the identification information of a speech input terminal via, for example, obtaining route r1. Obtaining route r1 is a route that uses a wide area network used outside the home. Obtaining route r1 passes through speech recognition server 22 and device control server 40. Obtaining route r1 is the route substantially identical to the obtaining route taken by first control unit 42 for obtaining speech control information. That is, second communication unit 51 obtains the identification information of a speech input terminal via an obtaining route identical to an obtaining route taken by first communication unit 41 for obtaining speech control information.

Second communication unit 51 may also obtain the identification information of a speech input terminal via obtaining route r2. Obtaining route r2 is a route that uses a local communication network used inside the home which covers an area more limited than an area which the wide area network used outside the home covers. Obtaining route r2 does not pass through speech recognition server 22 and device control server 40, Obtaining route r2 is the route different from the obtaining route taken by first control unit 42 for obtaining speech control information. That is, second communication unit 51 may obtain identification information of a speech input terminal via an obtaining route different from an obtaining route taken by first communication unit 41 for obtaining speech control information.

Second control unit 52 includes output unit 54 and device control unit 55. Second control unit 52 is realized by, for example, a microcomputer, but may be realized by a processor.

Output unit 54 outputs, based on the identification information obtained by second communication unit 51, control information for controlling target device to be controlled 50. For example, output unit 54 outputs, based on the speech control information obtained by first communication unit 41 (more specifically, the individualized command received by second communication unit 51) and the identification information of a speech input terminal which is obtained by second communication unit 51, control information for controlling target device to be controlled 50.

Device control unit 55 operates target device to be controlled 50, based on the control information outputted from output unit 54. When target device to be controlled 50 is an air conditioner, device control unit 55 operates target device to be controlled 50 to air-condition the home, based on the control information outputted from output unit 54.

Second storage unit 53 is a storage apparatus that stores a program etc. executed by second control nit 52. In addition, identification information of a particular speech input terminal is registered in second storage unit 53. Second storage unit 53 stores, in advance, the identification information of speech input terminal 21 and the identification information of speech input terminal 80, for example. Specifically, second storage unit 53 is realized by a semiconductor memory etc.

### [Operation Example 1 of Control System]

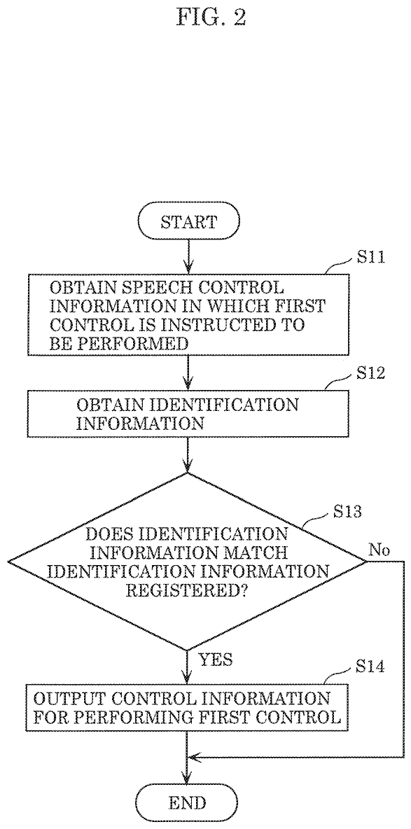

Next, Operation Example 1 of control system 30 will be described. FIG. 2 is a flowchart illustrating Operation Example 1 of control system 30 according to Embodiment 1.

First, first communication unit 41 obtains, by communicating with speech control system 20, speech control information in which first control is instructed to be performed (S11). In addition, second communication unit 51 obtains, from speech control system 20, identification information of a speech input terminal (S12). Note that “obtaining identification information from speech control system 20” means obtaining the identification information via at least one of the apparatuses included in speech control system 20.

Next, output unit 54 determines whether the identification information obtained in step S12 matches the identification information registered in second storage unit 53 (S13). That is, output unit 54 determines whether the identification information obtained in step S12 satisfies a predetermined requirement.

When output unit 54 determines that the identification information obtained matches the identification information registered in second storage unit 53 (YES in S13), output unit 54 outputs control information for performing first control on target, device to be controlled 50 (S14). For example, when target device to be controlled 50 is an air conditioner, and when the first control is the control for turning on the air conditioner, output unit 54 outputs control information for turning on target device to be controlled 50 (i.e. air conditioner).

On the contrary, when output unit 54 determines that the identification information obtained does not match the identification information registered in second storage 53 (NO in S13), output unit 54 does not output the control information for performing the first control on target device to be controlled 50. That is, output unit 54 does not follow the speech control information in which the first control is instructed to be performed, and disregards the speech control information.

With such Operation Example 1, only a speech inputted via a speech input terminal whose identification information is registered will be validated, and a speech inputted via a speech input terminal whose identification information is unregistered will be invalidated, thereby improving the security of control system 30.

### [Operation Example 2 of Control System]

Next, Operation Example 2 of control system 30 will be described. 3 is a flowchart illustrating Operation Example 2 of control system 30.

In Operation. Example 2, second communication unit 51 obtains positional information indicating the position of a speech input terminal as related information relevant to the speech input terminal. When the speech input terminal is a mobile terminal such as a smartphone, the positional information is obtained from a position detecting element such as a global positioning system (GPS) module included in the speech input terminal. When the speech input terminal is a stationary terminal, the positional information indicating an installation position is registered into a storage unit inside the speech input terminal at the time of installation, for example.

In addition, target area information used for the determination in step S23 is registered in second storage unit 53. The target area information is information indicating the positional range of a target area. In Operation Example 2, the target area information indicates the positional range inside the home. That is, the target area information is information for determining whether the position indicated in the positional information belongs to a position inside the home. Note that the target area is not limited to the inside of the home, and can be determined in any manner.

In the same manner as Operation Example 1, first communication unit 41 obtains speech control information in which first control is instructed to be performed (S21). Second communication unit 51 obtains positional information of a speech input terminal from speech control system 20 (S22). The positional information is outputted from the speech input terminal, and is obtained via speech recognition server 22, for example.

Next, output unit 54 determines whether the position indicated in the positional information obtained in step S22 belongs to a position inside the home, by referring to the target area information stored in second storage unit 53 (S23). That is, output unit 54 determines whether the speech input terminal, to which a speech from which the speech control information originates is inputted, is present inside the home. In this way, output unit 54 determines whether the positional information obtained in step S12 satisfies a predetermined requirement.

When output unit 54 determines that the position indicated in the positional information belongs to a position inside the home, or in other words, when the speech input terminal, to which a speech from which the speech control information originates is inputted, is estimated to be present inside the home (YES in S23), output unit 54 outputs control information for performing the first control on device control unit 55 of target device to be controlled 50 (S24). For example, when target device to be controlled 50 is an air conditioner, and when the first control is the control which causes the air conditioner to air-condition the home at 25° C., output unit 54 outputs the control information for causing target device to be controlled 50 (i.e. air conditioner) to air-condition the home at 25° C.

On the contrary, when output unit 54 determines that the position indicated in the positional information does not belong to a position inside the home, or in other words, when the speech input terminal, to which a speech from which the speech control information originates is inputted, is estimated to be present outside the home (NO in S23), output unit 54 outputs control information for performing second control on target device to be controlled 50 (S25). The second control is different from the first control instructed to be performed in the speech control information obtained in step S21. That is, when the speech control information obtained in step S11 is estimated to be not based on a speech uttered by a person present inside the home, output unit 54 does not follow the speech control information, and modifies the detail of control to be performed.

For example, when target device to be controlled 50 is an air conditioner, and when the first control is the control which causes the air conditioner to air-condition the home at 25° C., the second control is the control which causes the air conditioner to air-condition the home at 28° C. That is, since a person who has uttered a speech from which the speech control information originates is estimated to be absent from the home, output unit 54 modifies the detail of the control to be performed so as to avoid excessive air conditioning (reduction in electric power consumption). In other words, output unit 54 adaptively changes the detail of the control instructed to be performed in the speech control information.

With such Operation Example 2, target device to be controlled 50 is prevented from performing inappropriate operation when a user who has uttered a speech, from which the speech control information originates, is estimated to be absent from the home. That is, target device to be controlled 50 can be controlled according to a scene.

### [Operation Example 3 of Control System]

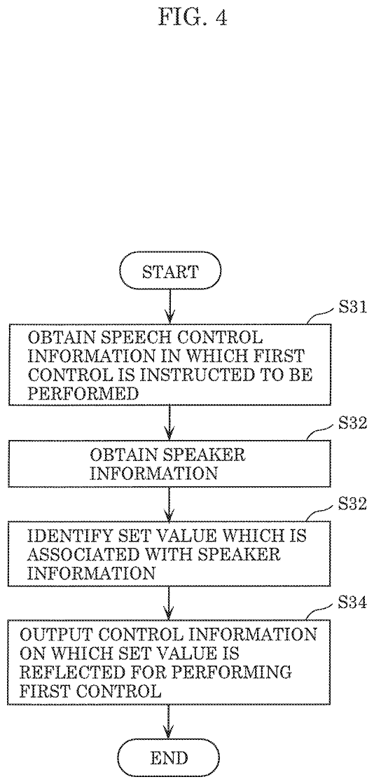

Next, Operation Example 3 of control system 30 will be described. FIG. 4 is a flowchart illustrating Operation Example 3 of control system 30.

In Operation Example 3, second communication unit 51 obtains speaker information indicating a speaker of a speech which is obtained by speech input terminal 21 as related information relevant to a speech input terminal. The speaker information is generated by, for example, speech recognition server 22 performing speaker-recognition processing on a speech signal outputted from speech input terminal 21, using a feature quantity of the speech signal.

In addition, second storage unit 53 stores setting information in which a plurality of users (speaker information) and a plurality of set values (e.g. temperature values to be set in an air conditioner) used for control are associated with one another.

First communication unit 41 obtains speech control information in which first control is instructed to be performed (S31). Second communication unit 51 obtains speaker information from speech control system 20 (more specifically, speech recognition server 22) (S32).

Next, output unit 54 identifies a set value which is associated with the speaker information obtained in step S32, by referring to setting information stored in second storage unit 53 (S33). Output unit 54 outputs control information, on which the set value identified in step S33 is reflected, for performing first control on device control unit 55 of target device to be controlled 50 (S34).

For example, target device to be controlled 50 air-conditions the home at a temperature value set according to the preference of a speaker when target device to be controlled 50 is an air conditioner, when the first control is control for air-conditioning the home, and when speaker information of the plurality of users are associated with respective temperature values set according to the preference of each user in the setting information.

With such Operation Example 3, target device to be controlled 50 can be caused to operate according to a setting preferred by a speaker, thereby improving the usability of control system 30.

### Variation 1

Operation Examples 1 through 3 may be suitably combined with one another. For example, in Operation Example 1, the first control may be performed only when identification information, positional information, and speaker information each satisfy a predetermined requirement. More specifically, the first control may be performed only when the identification information belongs to speech input terminal 21 provided inside a home, when a position indicated in the positional information belongs to a position inside the home, and when a speaker indicated in the speaker information is particular user A. In this case, the first control is not performed when the identification information belongs to speech input terminal 80, when a position indicated in the positional information belongs to a position outside the home, and when a speaker indicated in the speaker information is user B. In addition, the first control is also not performed when the identification information belongs to speech input terminal 21, when a position indicated in the positional information belongs to a position inside the home, and when a speaker indicated in the speaker information is user B.

Furthermore, in Operation Example 1, the first control may be performed when at least one of the identification information, the positional information, and the speaker information satisfies a predetermined requirement.

### Variation 2

Note that first communication unit 41 may obtain information about a direction from which a speech obtained by speech input terminal 21 is uttered. Output unit 54 may output control information, based on the information about the direction from which a speech is uttered and related information.

In this case, the direction from which a speech is uttered is detected by a sensor included in speech input terminal 21, and a speech input terminal generates information about an input of the speech. Speech input terminal 21 transmits, to speech recognition server 22, the information about the direction from which the speech obtained is uttered, in addition to a speech signal of the speech obtained.

The information about the direction from which the speech is uttered is obtained by first communication unit 41. For example, when the information about the direction from which the speech is uttered is used in the above Operation Example 1, the direction from which the speech is uttered is required to be a predetermined direction in order for first control to be performed. That is, the first control is performed when related information such as identification information satisfies a predetermined requirement; and when the direction indicated in the information about a direction from which the speech is uttered is the predetermined direction.

In addition, first communication unit 41 may obtain information about loudness (specifically, acoustic pressure) of a speech obtained by speech input terminal 21. Output unit 54 may output control information, based on the information about the loudness of a speech and related information.

In this case, the loudness of a speech is detected by a sensor included in speech input terminal 21, and a speech input terminal generates information about an input of the speech. Speech input terminal 21 transmits, to speech recognition server 22, information about the loudness of the speech obtained, in addition to a speech signal of the speech obtained.

The information about the loudness of a speech is obtained by first communication unit 41. For example, when information about the loudness of the speech is used in the above Operation Example 1, the loudness indicated in the information about the loudness of the speech is required to be at least predetermined loudness in order for first control to be performed. That is, the first control is performed when related information such as identification information satisfies a predetermined requirement, and when the loudness indicated in the information about the loudness of the speech is at least the predetermined loudness.

### Embodiment 2

### [Configuration]

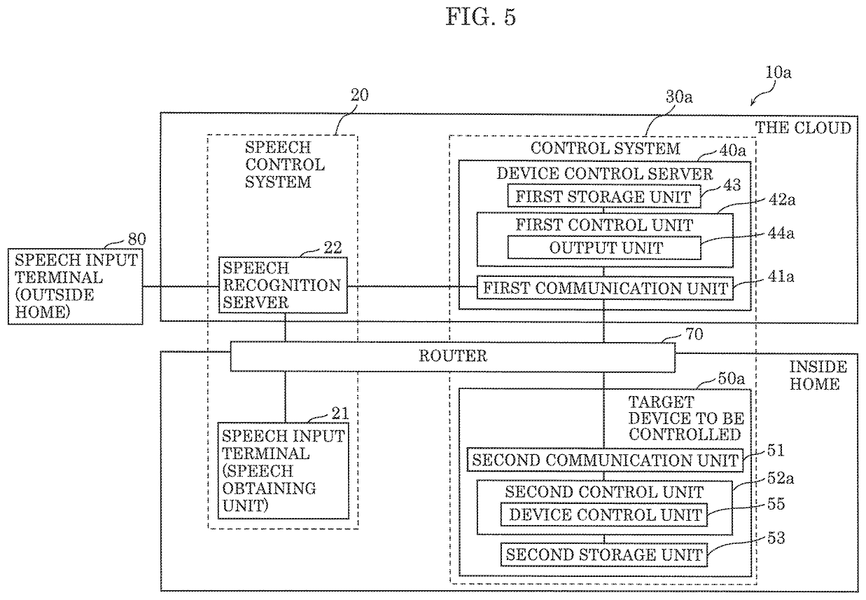

Next, a configuration of a speech recognition system according to Embodiment 2 will be described. FIG. 5 is a block diagram illustrating a functional configuration of a speech recognition system according to Embodiment 2. Note that following Embodiment 2 mainly describes differences from Embodiment 1, and thus the description of items that have already been described will be omitted or simplified. This also applies to other embodiments from Embodiment 3 onward.

As illustrated in FIG. 5, control system 30a included in speech recognition system 10a according to Embodiment 2 includes device control server 40a and target device to be controlled 50a.

In Embodiment 2, device control server 40a performs information processing using related information. Device control server 40a includes first communication unit 41a, first control unit 42a, and first storage unit 43.

First communication unit 41a communicates with speech control system 20. First communication unit 41a is one example of a first obtaining unit. Specifically, first communication unit 41 obtains speech control information by communicating with speech control system 20. In addition, first communication unit 41a is one example of a second obtaining unit, and obtains related information relevant to a speech input terminal from speech control system 20. First communication unit 41a is realized by, for example, a communication circuit.

First control unit 42a includes output unit 44a. First control unit 42a is realized by, for example, a microcomputer or a processor. Output unit 44a converts a control command obtained by first communication unit 41 into an individualized command for controlling target device to be controlled 50a provided inside a home.

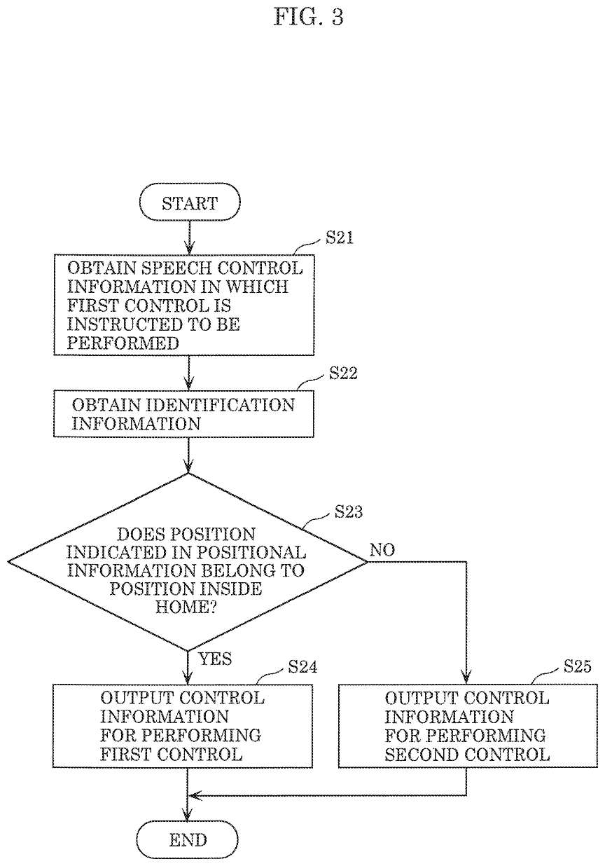

Output unit 44a also outputs, based on the related information obtained by first communication unit 41a, control information for controlling target device to be controlled 50a. Specifically output unit 44a performs information processing described in FIG. 2 through FIG. 4. The control information described here is the individualized command described above. Note that first storage 43 in Embodiment 2 stores various types of information (e.g. identification information, target area information, setting information, etc.) used for information processing using the related information.

When output unit 44a outputs the control information, first communication unit 41a transmits the control information to target device to be controlled 50a. When second communication unit 51 of target device to be controlled 50a receives the control information, device control unit 55 included in second control, unit 52a operates target device to be controlled 50a, based on the control information received.

As described above, instead of target device to be controlled 50a, device control server 40a performs information processing using related information in speech recognition system 10a. That is, a change made to the specifications of device control server 40a realizes control that is adaptively performed according to a situation in which a speech is inputted. In other words, control that is adaptively performed according to a situation in which a speech is inputted can be realized, while the scale of changes made to the specifications of target device to be controlled 50a is suppressed.

### Embodiment 3

### [Configuration]

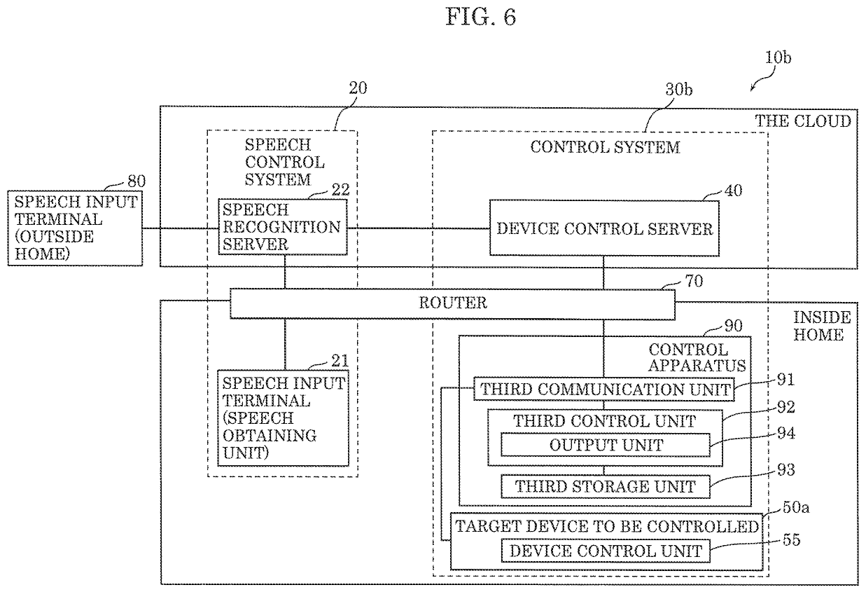

Next, a configuration of a speech recognition system according to Embodiment 3 will be described. FIG. 6 is a block diagram illustrating a functional configuration of a speech recognition system according to Embodiment 3. Note that in FIG. 6, the functional configuration of device control server 40 and the functional configuration of target device to be controlled 50a are simplified.

As illustrated in FIG. 6, control system 30b included in speech recognition system 10b according to Embodiment 3 includes device control server 40, control apparatus 90, and target device to be controlled 50a. In Embodiment 3, control apparatus 90 performs information processing using related information.

Control apparatus 90 is an apparatus that controls a device inside a home. Control apparatus 90 is, for example, a home energy management system (HEMS) controller (i.e. a home gateway). Control apparatus 90 includes third communication unit 91, third control unit 92, and third storage unit 93.

Third communication unit 91 receives, via router 70, an individualized command transmitted from first communication unit 41 of device control server 40. In addition, third communication unit 91 is one example of a second obtaining unit. Third communication unit 91 obtains related information relevant to a speech input terminal from speech control system 20. Third communication unit. 91 is realized by, for example, a communication circuit.

Third control unit 92 includes output unit 94. Third control unit 92 is realized by, for example, a microcomputer, but may be realized by a processor.

Output unit 94 outputs, based on speech control information obtained by first communication unit 41 (more specifically, an individualized command received by third communication unit 91) and the related information obtained by third communication unit 91, control information for controlling target device to be controlled 50a.

Third storage unit 93 is a storage apparatus that stores a program etc. executed by third control unit 92. Third storage unit 93 also stores various types of information (specifically, identification information, target area information, setting information, etc.) used for information processing using the related information. Specifically; third storage unit 93 is realized by a semiconductor memory etc.

When output unit 94 outputs control information, third communication unit 91 transmits the control information to target device to be controlled 50a via a local communication network used inside the home. When second communication unit 51 (not illustrated in FIG. 6) of target device to be controlled 50a receives the control information, device control unit 55 operates target device to be controlled 50a, based on the control information received.

As described above, instead of device control server 40 and target device to be controlled 50a, control apparatus 90 performs information processing using the related information in speech recognition system 10b. That is, the introduction of control apparatus 90 realizes control that is adaptively performed according to a situation in which a speech is inputted. In other words, control that is adaptively performed according to a situation in which a speech is inputted can be realized, while the scale of changes made to the specifications of device control server 40 and target device to be controlled 50a is suppressed.

### (Advantageous Effects, Etc.)

As described above, control system 30 includes: first communication unit 41 that obtains speech control information from speech control system 20 which outputs the speech control information for controlling a device based on a speech obtained by speech input terminal 21; and second communication unit 51 that obtains related information relevant to speech input terminal 21 from speech control system 20. Control system 30 is one example of a control information obtaining system, and speech input terminal 21 is one example of a speech obtaining unit. First communication unit 41 is one example of a first obtaining unit, and second communication unit 51 is one example of a second obtaining unit.

Such control system 30 can adaptively control a device according to a situation in which a speech is inputted to speech input terminal 21, by performing information processing using related information.

In addition, second communication unit 51 obtains the related information via an obtaining route identical to an obtaining route taken by first communication unit 41 for obtaining the speech control information, for example.

Such control system 30 can readily obtain related information via an obtaining route identical to an obtaining route taken by first communication unit 41 for obtaining speech control information.

In addition, second communication unit 51 obtains the related information via an obtaining route different from an obtaining route taken by first communication unit 41 for obtaining the speech control information, for example.

Such control system 30 can obtain related information that is highly reliable via an obtaining route different from an obtaining route taken by first communication unit 41 for obtaining speech control information, in the case where the obtaining route taken by first communication unit 41 is being hacked.

In addition, second communication unit 51 obtains the related information relevant to speech input terminal 21 provided in a space in which a person is estimated to be present, for example.

Such control system 30 can obtain related information relevant to speech input terminal 21, which is a stationary smart speaker etc.

In addition, control system 30 further includes output unit 54 that outputs, based on the speech control information obtained and the related information obtained, control information for controlling target device to be controlled 50, for example.

Such control system 30 can adaptively control, based on related information, target device to be controlled 50 according to a situation in which a speech is inputted.

In addition, when first communication unit 41 obtains the speech control information, output unit 54 outputs, based on the related information obtained, the control information for performing second control on target device to be controlled 50a, the second control being different from first control instructed to be performed in the speech control information, for example.

Such control system 30 can adaptively modify, based on related information, the detail of control performed on target device to be controlled 50.

In addition, when first communication unit 41 obtains the speech control information, output unit 54 (i) outputs the control information for performing the first control on target device to be controlled 50 when the related information obtained satisfies a predetermined requirement, and (ii) outputs the control information for performing the second control on target device to be controlled 50 when the related information obtained does not satisfy the predetermined requirement, for example.

Such control system 30 can adaptively modify, based on whether related information satisfies a predetermined requirement, the detail of control performed on target device to be controlled 50.

In addition, the related information obtained is identification information of speech input terminal 21, for example.

Such control system 30 can adaptively control a device according to identification information of speech input terminal 21 to which a speech is inputted.

In addition, the related information obtained indicates a position of speech input terminal 21, for example.

Such control system 30 can adaptively control a device according to a position of speech input terminal 21 to which a speech is inputted.

In addition, the related information obtained indicates a speaker of the speech Obtained by speech input terminal 21, for example.

Such control system 30 can adaptively control a device according to a speaker of a speech obtained by input terminal 21.

### Other Embodiments

The above has described the embodiments, yet the present invention is not limited to the above embodiments.

For example, the communication methods of communicating among apparatuses which are described in the above embodiments are not particularly limited to the above. For example, the wireless communication performed among apparatuses uses a communication standard such as specified low power radio, ZigBee (registered trademark), Bluetooth (registered trademark), or Wi-Fi (registered trademark). Note that the wireless communication is specifically radio communication or infrared communication, for example.

Instead of the wireless communication, wired communication may be performed among the apparatuses. Such wired communication may be power line communication (PLC), or communication performed using a wired LAN. The communication performed among the apparatuses may also be a combination of wireless communication and wired communication.

Furthermore, a process performed by a particular processing unit in the above embodiments may be performed by another processing unit. Moreover, the order of processes may be changed, and the processes may be performed in parallel.

In addition, the structural elements such as a control unit may be realized by executing a software program suitable for each structural element. Each structural element may be realized by means of a program executing unit, such as a CPU or a processor, reading and executing a software program recorded on a recording medium such as a hard disk or a semiconductor memory.

In addition, the structural elements such as a control unit may be realized by a hardware product. For example, the structural elements such as the control unit may be circuits or integrated circuits. These circuits may constitute a single circuit as a whole or may be individual circuits. Furthermore, each of these circuits may be a general-purpose circuit or may be a dedicated circuit.

Note that the general or specific aspects of the present invention may be realized by a system, an apparatus, a method, an integrated circuit, a computer program, or a computer-readable recording medium such as a CD-ROM. The general or specific aspects of the present invention may also be realized by any combination of a system, an apparatus, a method, an integrated circuit, a computer program, and a recording medium.

For example, the present invention may be realized as a target device to be controlled, a device control server, or a control apparatus. In addition, the present invention may be realized as a control information obtaining method, a program for causing a computer to execute the control information obtaining method, and a non-transitory computer-readable recording medium on which such a program is recorded.

Each of the systems described above may be realized as a single apparatus, and may also be realized by a plurality of apparatuses. When each system is realized by a plurality of apparatuses, the structural elements included in the systems described in the above embodiments may be allotted to the plurality of apparatuses in any manner.

The present invention also encompasses: embodiments achieved by applying various modifications conceivable to those skilled in the art to each embodiment; and embodiments achieved by optionally combining the structural elements and the functions of each embodiment without departing from the essence of the present invention.

### REFERENCE MARKS IN THE DRAWINGS

20 speech control system
21 speech input terminal (speech obtaining unit)
22 speech recognition se.
30, 30a, 30b, 30c control system (control information obtaining system)
41 first communication unit (first obtaining unit)
41a first communication unit (first obtaining unit, second obtaining unit)
44a, 54, 94 output unit
50, 50a target device to be controlled
51 second communication unit (second obtaining unit)
91 third communication unit (second obtaining unit)

1. A control information obtaining system, comprising:
a first obtaining unit configured to obtain speech control information from a speech control system that outputs the speech control information for controlling a device based on a speech obtained by a speech obtaining unit; and
a second obtaining unit configured to obtain related information relevant to the speech obtaining unit from the speech control system.

2. The control information obtaining system according to claim 1, wherein
the second obtaining unit is configured to obtain the related information via an obtaining route identical to an obtaining route taken by the first obtaining unit for obtaining the speech control information.

3. The control information obtaining system according to claim 1, wherein
the second obtaining unit is configured to obtain the related information via an obtaining route different from an obtaining route taken by the first obtaining unit for obtaining the speech control information.

4. The control information obtaining system according to claim 1, wherein
the second obtaining unit is configured to obtain the related information relevant to the speech obtaining unit provided in a space in which a person is estimated to be present.

5. The control information obtaining system according to claim 1, further comprising:
an output unit configured to output, based on the speech control information obtained and the related information obtained, control information for controlling a target device to be controlled.

6. The control information obtaining system according to claim 5, wherein
when the first obtaining unit obtains the speech control information, the output unit is configured to output, based on the related information obtained, the control information for performing second control on the target device to be controlled, the second control being different from first control instructed to be performed in the speech control information.

7. The control information obtaining system according to claim 6, wherein
when the first obtaining unit obtains the speech control information, the output unit is configured to:
output the control information for performing the first control on the target device to be controlled when the related information obtained satisfies a predetermined requirement; and
output the control information for performing the second control on the target device to be controlled when the related information obtained does not satisfy the predetermined requirement.

8. The control information obtaining system according to claim 1, wherein
the related information obtained is identification information of the speech obtaining unit.

9. The control information obtaining system according to claim 1, wherein
the related information obtained indicates a position of the speech obtaining unit.

10. The control information obtaining system according to claim 1, wherein
the related information obtained indicates a speaker of the speech obtained by the speech obtaining unit.

11. A control information obtaining method, comprising:
obtaining speech control information from a speech control system that outputs the speech control information for controlling a device based on a speech obtained by a speech obtaining unit; and
obtaining related information relevant to the speech obtaining unit from the speech control system.

12. A non-transitory computer-readable recording medium for use in a computer, the recording medium having a computer program recorded thereon for causing the computer to execute the control information obtaining method according to claim 11.
